(19) United States
(12) Patent Application Publication
(10) Pub. No.: US 2025/0331564 A1
(43) Pub. Date: Oct. 30, 2025

(54) AEROSOL GENERATING DEVICE AND MICROWAVE HEATING ASSEMBLY THEREFOR

(71) Applicant: SMOORE INTERNATIONAL HOLDINGS LIMITED, George Town (KY)

(72) Inventors: Yonghai LAN, Shenzhen (CN); Jing DU, Shenzhen (CN); Yang DENG, Shenzhen (CN); Feng LIANG, Shenzhen (CN); Dongjian LI, Shenzhen (CN); Guihua BU, Shenzhen (CN)

(21) Appl. No.: 19/261,216

(22) Filed: Jul. 7, 2025

Related U.S. Application Data
(63) Continuation of application No. PCT/CN2023/070537, filed on Jan. 4, 2023.

(51) Int. Cl. A24F 40/46; H05B 6/64

(52) U.S. Cl. CPC A24F 40/46; H05B 6/64

(57) ABSTRACT

A microwave heating assembly for an aerosol generating device including: an outer conductor unit having: an outer conductor cylinder in a cylindrical shape and comprising an opened end and a closed end opposite the opened end, and at least one first radiation structure arranged on an inner peripheral wall surface of the outer conductor cylinder; and an inner conductor unit arranged in the outer conductor cylinder, one end of the inner conductor unit being connected to an end wall of the closed end, and an other end of the inner conductor unit extending towards the opened end, the inner conductor unit including: at least one second radiation structure corresponding to the at least one first radiation structure.

### CROSS-REFERENCE TO PRIOR APPLICATION

This application is a continuation of International Patent Application No. PCT/CN2023/070537, filed on Jan. 4, 2023. The entire disclosure is hereby incorporated by reference herein.

### FIELD

The present disclosure relates to the technical field of aerosol generation, and in particular, to an aerosol generating device and a microwave heating assembly therefor.

### BACKGROUND

A microwave heating type aerosol generating device in the related art can heat an aerosol-generating article through microwaves, so as to extract an aerosol. The aerosol generating device generally includes a microwave heating assembly. A microwave heating region can be formed in the microwave heating assembly and transfer microwave energy to the aerosol-generating article. In such a process, an effect of microwave heating is closely related to a distribution field of the microwave energy.

However, during actual application, since the microwave energy heats the aerosol-generating article according to inherent distribution, energy utilization efficiency is not high, or the energy is excessively dispersed. In consequence, an amount of the aerosol generated by the aerosol-generating article is small, and a heating speed or an aerosol generation speed is slow.

### SUMMARY

In an embodiment, the present invention provides a microwave heating assembly for an aerosol generating device, comprising: an outer conductor unit, comprising: an outer conductor cylinder in a cylindrical shape and comprising an opened end and a closed end opposite the opened end, and at least one first radiation structure arranged on an inner peripheral wall surface of the outer conductor cylinder; and an inner conductor unit arranged in the outer conductor cylinder, one end of the inner conductor unit being connected to an end wall of the closed end, and an other end of the inner conductor unit extending towards the opened end, and the inner conductor unit comprising: at least one second radiation structure corresponding to the at least one first radiation structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an outside of a microwave heating assembly according to some embodiments of the present disclosure;

FIG. 2 is a sectional view of a longitudinal structure of the microwave heating assembly shown in FIG. 1 in the first direction;

FIG. 3 is a schematic structural diagram of the microwave heating assembly shown in FIG. 1 in an exploded state;

FIG. 4 is a sectional view of a longitudinal structure of the microwave heating assembly shown in FIG. 1 in an exploded state;

FIG. 5 is a sectional view of a transverse structure of the microwave heating assembly according to some embodiments of the present disclosure from a top view;

FIG. 6 is a sectional view of a longitudinal structure of the microwave heating assembly shown in FIG. 1 in the second direction;

FIG. 7 is an enlarged schematic structural diagram of an accommodation base according to some embodiments of the present disclosure; and

FIG. 8 is a diagram of energy distribution acting on an aerosol-generating article of the microwave heating assembly according to some embodiments of the present disclosure.

### DETAILED DESCRIPTION

In an embodiment, the present invention provides an aerosol generating device and a microwave heating assembly therefor.

In an embodiment, the present invention provides a microwave heating assembly for the aerosol generating device, the microwave heating assembly including:
an outer conductor unit, where the outer conductor unit includes:
an outer conductor cylinder, where the outer conductor cylinder is in a cylindrical shape and includes an opened end and a closed end opposite the opened end; and
at least one first radiation structure, where the at least one first radiation structure is arranged on the inner peripheral wall surface of the outer conductor cylinder; and
an inner conductor unit, where the inner conductor unit is arranged in the outer conductor cylinder, one end of the inner conductor unit is connected to the end wall of the closed end, and the other end of the inner conductor unit extends towards the opened end; and the inner conductor unit includes:
at least one second radiation structure, where the at least one second radiation structure corresponds to the at least one first radiation structure.

In some embodiments, the at least one second radiation structure and the at least one first radiation structure are adjacent to each other and are arranged on a circumference of the central axis of the outer conductor cylinder separately.

In some embodiments, the at least one first radiation structure is in an elongated shape, and the length direction of the at least one first radiation structure is arranged in the length direction of the outer conductor cylinder.

In some embodiments, the length direction of the at least one first radiation structure is parallel to the central axis of the outer conductor cylinder.

In some embodiments, the at least one second radiation structure is in an elongated shape and is parallel to the at least one first radiation structure.

In some embodiments, the at least one first radiation structure includes a first end and a second end opposite the first end, and the first end is relatively farther away from the opened end;
the at least one second radiation structure includes a first fixed end and a first free end opposite the first fixed end, and the first fixed end is relatively farther away from the opened end;
the first end is relatively closer to the first fixed end, and the second end is relatively farther away from the first free end; or the first end is relatively farther away from the first fixed end, and the second end is relatively closer to the first free end.

In some embodiments, the inner conductor unit further includes a conductor disk, the conductor disk includes a first surface towards the closed end and a second surface opposite the first surface, and the first surface is connected to the end wall of the closed end; and
the at least one second radiation structure includes a first fixed end and a first free end opposite the first fixed end, the first fixed end is fixed to the portion, closest to the edge, of the second surface, and the first free end extends towards the opened end.

In some embodiments, the conductor disk in a disk shape, the outer conductor cylinder is in a cylindrical shape, and the diameter of the conductor disk is smaller than the inner diameter of the outer conductor cylinder.

In some embodiments, the inner conductor unit includes a conductor post, and the conductor disk is connected to the end wall of the closed end through the conductor post; and
the conductor post includes a second fixed end and a second free end opposite the second fixed end, the second fixed end is fixed to the end wall of the closed end, and the second free end extends in the direction of the conductor disk and is connected to the first surface.

In some embodiments, a recess dented in the direction of the opened end is formed in the first surface; and the second free end extends into the recess and is connected to the bottom of the recess.

In some embodiments, the recess, the conductor post, the conductor disk, and the outer conductor cylinder are coaxial.

In some embodiments, the wall surface, farthest away from the central axis of the outer conductor cylinder, of the at least one second radiation structure is flush with the outer peripheral side surface of the conductor disk.

In some embodiments, the outer conductor cylinder is partitioned off to form one accommodation cavity, and the at least one first radiation structure and the at least one second radiation structure are arranged at the periphery of the accommodation cavity separately.

In some embodiments, the microwave heating assembly further includes an accommodation base mounted at the opened end, where the accommodation base includes an accommodation portion in a cylindrical shape and used for defining the accommodation cavity.

In some embodiments, the wall surfaces, adjacent to the central axis of the outer conductor cylinder, of the at least one first radiation structure and the at least one second radiation structure are located at the periphery of the accommodation portion.

In some embodiments, the at least one first radiation structure and the at least one second radiation structure are partially embedded in the outer peripheral side wall of the accommodation portion.

In some embodiments, the wall surfaces, adjacent to the central axis of the outer conductor cylinder, of the at least one first radiation structure and the at least one second radiation structure are flush with the inner peripheral wall surface of the accommodation portion.

In some embodiments, the wall surfaces, adjacent to the central axis of the outer conductor cylinder, of the at least one first radiation structure and the at least one second radiation structure are located inside the accommodation portion.

In some embodiments, the accommodation base further includes a fixing portion connected to the accommodation portion, and the fixing portion is mounted at the opened end and includes one through hole enabling the accommodation cavity to be in communication with the outside.

In some embodiments, the accommodation portion includes an accommodation bottom wall opposite the opened end and an accommodation side wall arranged around the periphery of the accommodation bottom wall;
the accommodation base further includes a first vent recess and a second vent recess;
the first vent recess is formed in the end surface, towards the opened end, of the accommodation bottom wall, and the second vent recess is formed in the inner peripheral wall surface of the accommodation side wall and the inner peripheral wall surface of the through hole; and the first vent recess is in communication with the outside through the second vent recess.

In some embodiments, the first vent recess is in a sector shape; and the side, having a greater arc length, of the first vent recess is adjacent to the first radiation structure or the second radiation structure, and the side, having a smaller arc length, of the first vent recess is adjacent to the second vent recess.

In some embodiments, the extension direction of the second vent recess is parallel to the central axis of the outer conductor cylinder.

In some embodiments, the outer conductor unit includes a first cylinder body and a second cylinder body that are capable of being axially combined and connected;
the opened end is formed at the end, farthest away from the second cylinder body, of the first cylinder body, and the accommodation portion and the at least one first radiation structure are arranged in the first cylinder body; and
the closed end is formed at the end, farthest away from the first cylinder body, of the second cylinder body, and the inner conductor unit is arranged in the second cylinder body.

In some embodiments, the end surface of the end, farthest away from the opened end, of the at least one first radiation structure is flush with the end surface, adjacent to the second cylinder body, of the first cylinder body.

In some embodiments, the microwave heating assembly further includes a microwave feed-in unit; where the microwave feed-in unit includes:
an outer conductor, where the outer conductor is mounted on the second cylinder body and is in ohmic contact with the outer conductor unit;
an inner conductor, where the inner conductor is arranged in the outer conductor and is in ohmic contact with the inner side of the second cylinder body or the inner conductor unit; and
a substrate layer, where the substrate layer is located between the outer conductor and the inner conductor.

In some embodiments, the second cylinder body is provided with a feeding hole enabling the inside of the second cylinder body to be in communication with the outside;
the outer conductor is embedded in the feeding hole and is in ohmic contact with the inner wall surface of the feeding hole; and the inner conductor passes through the feeding hole, to extend into the second cylinder body.

The present disclosure further constructs an aerosol generating device. The aerosol generating device includes a microwave generating assembly, and further includes the above microwave heating assembly, where the microwave heating assembly is connected to the microwave generating assembly.

### BENEFICIAL EFFECTS

After implementation, the present disclosure has the beneficial effects as follows: Through mutual cooperation between the first radiation structure and the second radiation structure, an energy field in the microwave heating assembly is concentratively distributed, so as to concentratively heat the region, corresponding to the first radiation structure and the second radiation structure, of the aerosol-generating article. Accordingly, a heating speed is effectively improved.

Reference numerals: microwave heating assembly 100; outer conductor unit 11; inner conductor unit 12; accommodation base 13; closed end 111; opened end 112; chamber 113; outer conductor cylinder 114; first radiation structure 115; first cylinder body 1141; second cylinder body 1142; first cavity section 1143; second cavity section 1144; feeding hole 1145; mounting hole 1146; first end 1151; second end 1152; conductor post 121; conductor disk 122; connection rod 123; second radiation structure 124; insertion hole 1211; recess 1221; first fixed end 1241; first free end 1242; accommodation portion 131; fixing portion 132; first vent recess 133; second vent recess 134; accommodation cavity 1311; accommodation side wall 1312; accommodation bottom wall 1313; first avoidance recess 1314; second avoidance recess 1315; through hole 1321; first distance D; and circumference Y.

In the following description, for the purpose of description rather than limitation, specific details such as a specific system structure and technology are provided to thoroughly understand embodiments of the present disclosure. However, those skilled in the art should be aware that the present disclosure can alternatively be implemented in other embodiments without these specific details. In other cases, detailed descriptions of known systems, devices, circuits, and methods are omitted to avoid unnecessary details hindering the description of the present disclosure.

An aerosol generating device is provided according to some embodiments of the present disclosure. The aerosol generating device may heat an aerosol-generating article through microwaves, so as to generate an aerosol to be inhaled by a user. The aerosol-generating article may be a solid aerosol-generating article such as a processed plant leaf product. Understandably, the aerosol-generating article is not limited to a solid product. In some other embodiments, the aerosol-generating article can alternatively be a liquid aerosol-generating article.

In some embodiments, the aerosol generating device may include a microwave generating assembly and a microwave heating assembly 100. The microwave generating assembly may be used for generating a microwave signal. The microwave heating assembly 100 is connected to the microwave generating assembly and is used for heating the aerosol-generating article through microwaves.

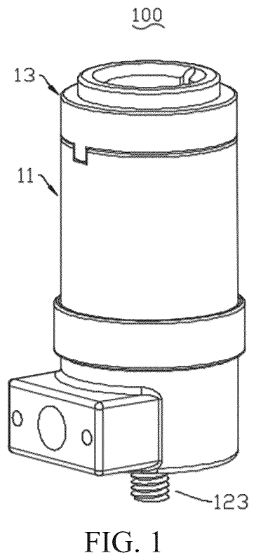

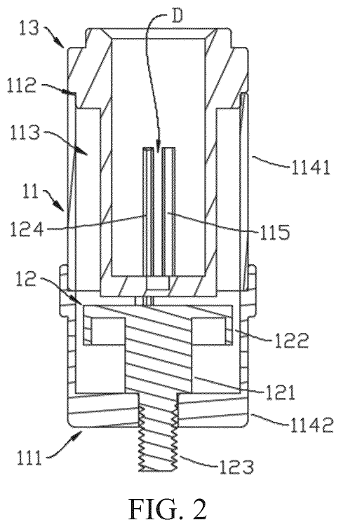

As shown in FIG. 1 and FIG. 2, in some embodiments, the microwave heating assembly 100 may be in a cylindrical shape substantially and include an outer conductor unit 11, an inner conductor unit 12, an accommodation base 13, and a microwave feed-in unit. The outer conductor unit 11 may be in a cylindrical shape. The inner conductor unit 12 may coaxially penetrate the outer conductor unit 11 and forms a microwave heating cavity based on a quarter-wave coaxial resonant cavity with the outer conductor unit 11. The microwave heating cavity may include a short-circuit end and an open-circuit end.

In some embodiments, the outer conductor unit 11 is provided with a closed end 111 and an opened end 112 opposite the closed end 111. In addition, a semi-closed cylindrical chamber 113 is defined by the outer conductor unit 11. The inner conductor unit 12 may be used for adjusting a resonance frequency and microwave distribution. The inner conductor unit 12 is coaxially arranged in the outer conductor unit 11. One end of the inner conductor unit is connected to the closed end 111 of the outer conductor unit 11 and is in ohmic contact with the end wall of the closed end 111, so as to form the short-circuit end of the microwave heating cavity. The other end of the inner conductor unit 12 extends towards the opened end 112 of the outer conductor unit 11 and is not in contact with the outer conductor unit 11, so as to form the open-circuit end of the microwave heating cavity.

The accommodation base 13 is detachably and coaxially mounted at the opened end 112 of the outer conductor unit 11 and used for loading the aerosol-generating article and holding the aerosol-generating article in the chamber 113.

The microwave feed-in unit is used for feeding the microwaves generated by the microwave generating assembly into the chamber 113 (in an electrical feed-in manner or a magnetic feed-in manner, and preferably, in the electrical feed-in manner). The microwave feed-in unit is detachably mounted on the outer peripheral wall of the outer conductor unit 11.

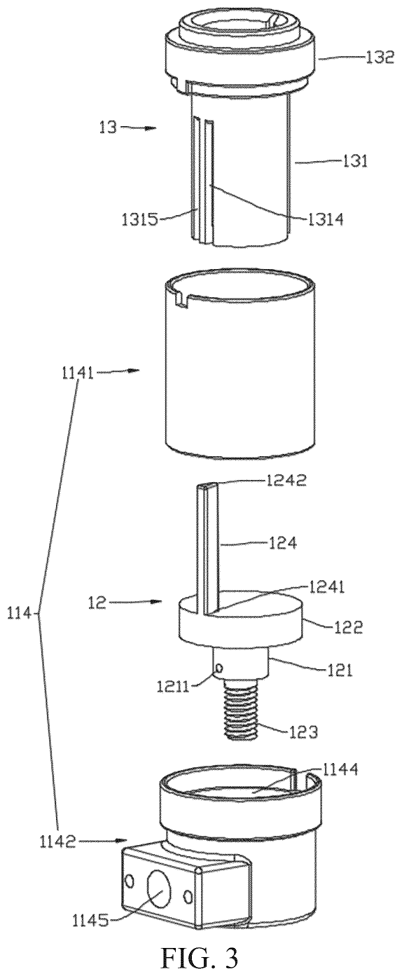

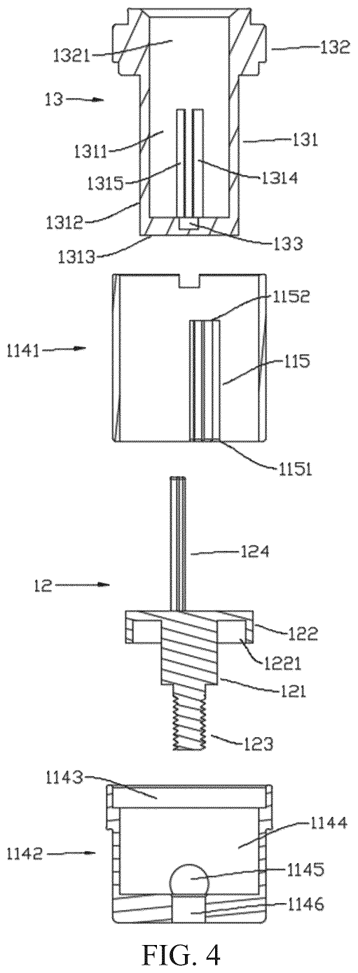

In some embodiments, as shown in FIG. 3 and FIG. 4, the outer conductor unit 11 includes an outer conductor cylinder 114 substantially in a cylindrical shape. The outer conductor cylinder 114 includes a first cylinder body 1141 and a second cylinder body 1142 that are capable of being axially combined. The first cylinder body 1141 and the second cylinder body 1142 are in communication with each other and jointly define the chamber 113. The first cylinder body 1141 is in a cylindrical shape. Two axial ends of the first cylinder body are of an opening structure. The top end of the first cylinder body 1141 forms the opened end 112 of the outer conductor unit 11. The second cylinder body 1142 is in a cylindrical shape. The top end of the second cylinder body is of an opening structure and is connected to the bottom end of the first cylinder body 1141. The bottom end of the second cylinder body 1142 is of a closed structure to form the closed end 111 of the outer conductor unit 11.

The second cylinder body 1142 includes a first cavity section 1143 and a second cavity section 1144 that are axially connected. The first cavity section 1143 is relatively adjacent to the first cylinder body 1141, and the diameter of the first cavity section 1143 is greater than that of the second cavity section 1144. Thus, the step surface is formed between the first cavity section 1143 and the second cavity section 1144. The bottom end of the first cylinder body 1141 may be connected to the first cavity section 1143 and abut against the step surface. Snap fit, threaded connection, etc. may be employed for the connection.

The position, relative to the second cavity section 1144, of the second cylinder body 1142, is further provided with a radially-through feeding hole 1145. The feeding hole 1145 may allow one end of the microwave feed-in unit to extend into the chamber 113.

The end wall of the bottom end of the second cylinder body 1142 is further provided with a centrally and axially-through mounting hole 1146. The mounting hole 1146 is used for allowing the inner conductor unit 12 to be fixed thereto.

As further shown in FIG. 2 and FIG. 4, the outer conductor unit 11 further includes a first radiation structure 115 connected to (integrally combined or in ohmic contact with) the inner peripheral wall surface of the first cylinder section and used for cooperating with the inner conductor unit 12, so as to change a distribution state of a microwave field. The first radiation structure 115 may be of an elongated structure. The length direction of the first radiation structure may be parallel to the central axis of the outer conductor unit 11. The wall surface of a longer side of the first radiation structure 115 is attached to the inner peripheral wall surface of the first cylinder section. In some embodiments, a cross section of the first radiation structure 115 may be in different shapes, such as a rectangular shape, a sector shape, and a special shape. The first radiation structure 115 is provided with a first end 1151 and a second end 1152 that are opposite each other. The first end 1151 is closer to the closed end 111, and the second end 1152 is closer to the opened end 112.

In some embodiments, the outer conductor cylinder 114 and the first radiation structure 115 are integrally made of a conductive metal material (for example, aluminum alloy or copper). Understandably, the outer conductor cylinder 114 and the first radiation structure 115 may be integrally made of the conductive material, or may be implemented by plating the inner wall surface of a non-conductive body with a first conductive coating. The first conductive coating may be made of gold, silver, conductive metal oxide, etc. Preferably, the first conductive coating is a silver coating or a gold coating.

As shown in FIG. 2 to FIG. 4, the inner conductor unit 12 is mounted in the second cylinder body 1142. The inner conductor unit 12 may include a conductor post 121, a conductor disk 122 arranged at the top end of the conductor post 121, and a second radiation structure 124 connected to the portion, closest to the edge, of the conductor disk 122. Preferably, the central axis of the conductor post 121, the central axis of the conductor disk 122, and the central axis of the outer conductor unit 11 coincide with one another.

In the embodiment, the conductor post 121 may be in a cylindrical shape. Certainly, the conductor post 121 may alternatively be in a square cylindrical shape, an elliptical cylindrical shape, a staircase cylindrical shape, an irregular cylindrical shape, etc., instead of being limited to the cylindrical shape. The diameter of the conductor post 121 is smaller than the inner diameter of the second cylinder body 1142. The bottom end (the second fixed end) of the conductor post 121 is coaxially fixed to the end wall of the bottom end of the second cylinder body 1142, and the top end (the second free end) of the conductor post 121 extends longitudinally upwards.

The conductor post 121 is further provided with an insertion hole 1211 relative to the feeding hole 1145. The insertion hole 1211 is used for allowing the inner conductor of the microwave feed-in unit to be inserted therein, so as to improve connection reliability between the conductor post 121 and the inner conductor. The insertion hole 1211, a blind hole, is a straight cylindrical channel and radially extends towards the inside of the conductor post 121 along the outer peripheral wall of the conductor post 121.

The bottom end of the conductor post 121 is further connected to an axially-extending connection rod 123. The connection rod 123 may be integrally combined with the conductor post 121 and is used for being mounted in a mounting hole 1146 in the second cylinder body 1142, so as to reliably fix the conductor post 121 to the second cylinder body 1142.

In the embodiment, the conductor disk 122 is in a disk shape. Certainly, the conductor disk 122 may alternatively be in a square post shape, a circular truncated cone shape, etc., instead of being limited to the disk shape. The diameter of the conductor disk 122 is smaller than the inner diameter of the second cylinder body 1142. The uniform second distance is provided between the outer peripheral side wall of the conductor disk 122 and the inner peripheral side wall of the outer conductor unit 11.

The conductor disk 122 is coaxially arranged at the top end of the conductor post 121. The conductor disk 122 and the conductor post 121 may be integrally combined or in ohmic contact. With further reference to FIG. 3 and FIG. 4, in some embodiments, the diameter of the conductor disk 122 may be greater than that of the conductor post 121. The conductor disk 122 includes the first surface facing the conductor post 121 and a second surface facing away from the first surface. A recess 1221 dented in the direction of the opened end 112 is formed in the first surface. The recess 1221 may be in a cylindrical shape and coaxially formed in the conductor disk 122. The diameter of the recess 1221 may be greater than that of the conductor post 121. Thus, the top end of the conductor post 121 extends into the recess 1221 and is fixedly connected to the bottom of the recess 1221. The uniform third distance is provided between the outer peripheral side wall of the conductor post 121 and the recess side wall of the recess 1221. Understandably, by accommodating part of the structures of the conductor post 121 in the conductor disk 122, electrical performance is not affected while the axial length of an entire inner conductor unit 12 is reduced.

As further shown in FIG. 3 and FIG. 4, in some embodiments, the second radiation structure 124 may be in an elongated shape. The length direction of the second radiation structure may be parallel to the central axis of the outer conductor unit 11. A cross section of the second radiation structure 124 may be in a rectangular shape, a sector shape, or an irregular shape. The second radiation structure 124 is provided with a first fixed end 1241 and a first free end 1242 that are opposite each other. The first fixed end 1241 is connected to the peripheral edge of the second surface of the conductor disk 122, and the first free end 1242 extends longitudinally upwards. Preferably, the portion, adjacent to the second cylinder body 1142, of the surface of the second radiation structure 124 is flush with the outer peripheral side surface of the conductor disk 122.

The conductor post 121, the conductor disk 122, and the second radiation structure 124 are integrally made of a conductive metal material. The metal material is preferably aluminum alloy or copper. Understandably, the conductor post 121, the conductor disk 122, and the second radiation structure 124 may be integrally made of the conductive material, or may be implemented by plating the inner wall surface of a non-conductive body with a second conductive coating. The second conductive coating may be made of gold, silver, conductive metal oxide, etc. Preferably, the second conductive coating is a silver coating or a gold coating.

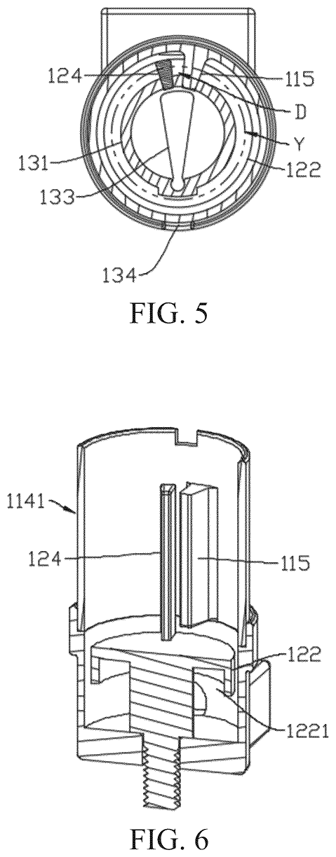

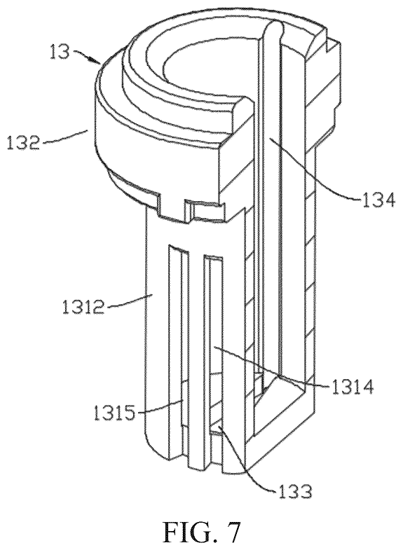

As shown in FIG. 5 and FIG. 6, the first radiation structure 115 and the second radiation structure 124 are oppositely arranged at the outer periphery of the aerosol-generating article. The first radiation structure 115 and the second radiation structure 124 are arranged side by side on the circumference Y of the central axis of the outer conductor unit 11 (in the embodiment, as shown in FIG. 5, the circumference Y is between the outer peripheral side surface of the conductor disk 122 and the inner peripheral wall surface of the first cylinder body 1141 from the top view). The first radiation structure 115 and the second radiation structure 124 are oppositely arranged on the circumference Y, and the first distance D is provided between the first radiation structure and the second radiation structure. The first radiation structure 115 and the second radiation structure 124 cooperate to jointly change the form of the microwave field. Thus, a longitudinal and concentratively-distributed microwave field is formed to concentratively heat the corresponding region of the aerosol-generating article. Accordingly, time required for complete heating is shortened, and a good instant effect is achieved.

In some embodiments, as further shown in FIG. 5 and FIG. 6, the first radiation structure 115 and the second radiation structure 124 are parallel to each other. The length direction of the first radiation structure and the length direction of the second radiation structure are parallel to the central axis of the outer conductor unit 11. Understandably, the first radiation structure 115 and the second radiation structure 124 may alternatively be arranged in a splayed shape. Specifically, the first end 1151 of the first radiation structure 115 is relatively closer to the first fixed end 1241 of the second radiation structure 124, and the second end 1152 of the first radiation structure 115 is relatively farther away from the first free end 1242 of the second radiation structure 124. Alternatively, the first end 1151 of the first radiation structure 115 is relatively farther away from the first fixed end 1241 of the second radiation structure 124, and the second end 1152 of the first radiation structure 115 is relatively closer to the first free end 1242 of the second radiation structure 124.

As further shown in FIG. 3 and FIG. 4, the accommodation base 13 includes an accommodation portion 131 and a fixing portion 132 integrally connected to the accommodation portion 131. The accommodation portion 131 is used for accommodating the aerosol-generating article. The fixing portion 132 is used for axially blocking the opened end 112 of the outer conductor unit 11 and relatively fixing the accommodation portion 131 in the chamber 113.

The accommodation portion 131 may be in a cylindrical shape. The outer diameter of the accommodation portion may be smaller than the inner diameter of the first cylinder body 1141. The accommodation portion is coaxially arranged in the first cylinder body 1141. The accommodation portion 131 forms an axial accommodation cavity 1311 used for accommodating the aerosol-generating article.

In the embodiment, the accommodation portion 131 includes an accommodation side wall 1312 in a cylindrical shape and an accommodation bottom wall 1313 blocking one end of the accommodation side wall 1312. The accommodation bottom wall 1313 is opposite the opened end 112 of the outer conductor unit 11 and is used for holding the aerosol-generating article.

A first avoidance recess 1314 and a second avoidance recess 1315 that are adjacent and spaced are further formed in the accommodation side wall 1312. The first avoidance recess 1314 is in an elongated shape, the shape and size of which are adapted to those of the first radiation structure 115. The first avoidance recess is used for allowing the first radiation structure 115 to be embedded therein. The second avoidance recess 1315 is in an elongated shape, the shape and size of which is adapted to those of the second radiation structure 124. The second avoidance recess is used for allowing the second radiation structure 124 to be embedded therein.

Understandably, as shown in FIG. 5, the first radiation structure 115 and the second radiation structure 124 are oppositely located in the peripheral direction of the accommodation portion 131. The first radiation structure 115 and the second radiation structure 124 are embedded in the accommodation side wall 1312 through the first avoidance recess 1314 and the second avoidance recess 1315 respectively. Preferably, the wall surfaces, adjacent to the central axis of the outer conductor unit 11 separately, of the first radiation structure 115 and the second radiation structure 124 are flush with the inner peripheral surface of the accommodation side wall 1312. Certainly, the mapping relationship between the first radiation structure 115 as well as the second radiation structure 124 and the accommodation portion 131 is not limited to the case in which the first radiation structure and the second radiation structure are embedded in the accommodation portion 131. The first radiation structure 115 and the second radiation structure 124 may alternatively be arranged at the periphery of the accommodation portion 131. The wall surfaces, adjacent to the central axis of the outer conductor unit 11 separately, of the first radiation structure 115 and the second radiation structure 124 are oriented towards the outer peripheral surface of the accommodation side wall 1312. Alternatively, part of the structures of the first radiation structure 115 and the second radiation structure 124 are embedded inside the accommodation portion 131. The wall surfaces, adjacent to the central axis of the outer conductor unit 11 separately, of the first radiation structure 115 and the second radiation structure 124 are located inside the accommodation portion 131.

The fixing portion 132 may be in an annular shape and is coaxially connected to the accommodation portion 131. The fixing portion 132 may coaxially block the opened end 112 of the outer conductor unit 11, so that the accommodation portion 131 is relatively fixed in the chamber 113 coaxially. The fixing portion 132 includes an axial through hole 1321 enabling the accommodation cavity 1311 to be in communication with the external environment. The aerosol-generating article is capable of being inserted into the accommodation cavity 1311 through the through hole 1321.

As shown in FIG. 5 and FIG. 7, the accommodation base 13 further includes a first vent recess 133 formed in the accommodation bottom wall 1313 and a second vent recess 134 formed in the accommodation side wall 1312 and the inner peripheral wall of the through hole 1321. The first vent recess 133 is in communication with the outside (the outside of the outer conductor unit 11) through the second vent recess 134. Thus, ambient air is drawn into the bottom of the aerosol-generating article, and then enters the aerosol-generating article to take away an aerosol generated through microwave heating.

The first vent recess 133 is in a sector shape. The side, having a greater arc length, of the first vent recess 133 is adjacent to the first radiation structure 115 or the second radiation structure 124, and the side, having a smaller arc length, of the first vent recess 133 is adjacent to the second vent recess 134.

The second vent recess 134 is provided at the side opposite the first radiation structure 115 or the second radiation structure 124. The second vent recess 134 is in an elongated shape. The extension direction of the second vent recess is parallel to the central axis of the outer conductor unit 11.

In the embodiment, the microwave feed-in unit may be a coaxial connector inserted into the feeding hole 1145 in the second cylinder body 1142 and mounted on the outer conductor unit 11. The microwave feed-in unit includes an outer conductor, an inner conductor arranged in the outer conductor, and a substrate layer between the inner conductor and the outer conductor.

The outer conductor may be of a straight cylinder structure with opening structures at two ends. When the microwave feed-in unit is mounted on the outer conductor unit 11, the outer peripheral side surface of the outer conductor is in ohmic contact with the inner wall surface of the feeding hole 1145.

The inner conductor is of a linear needle-shaped structure. One end of the inner conductor is the connection end located inside the outer conductor. The other end of the inner conductor is the feed-in end located outside the outer conductor. The connection end of the inner conductor is used for being connected to the microwave generating assembly, so as to receive microwaves. A coaxial connection manner or a microstrip line connection manner may be employed for the connection. The feed-in end is relatively adjacent to the inner conductor unit 12 when the microwave feed-in unit is mounted on the outer conductor unit 11, and is inserted into the insertion hole 1211 in the conductor post 121 to implement electrical coupling or magnetic coupling.

Certainly, the inner conductor may alternatively be in an L shape, instead of being limited to a linear shape. The inner conductor may include a first section perpendicular to the central axis of the microwave heating assembly 100 and a second section parallel to the central axis of the microwave heating assembly 100. The first section is partially located in the outer conductor and integrally connected to one end of the second section. The other end of the second end 1152 is located outside the outer conductor and is in direct ohmic contact with the end wall of the bottom end of the second cylinder body 1142.

The actions of the first radiation structure 115 and the second radiation structure 124 are specifically described below by performing operation tests on the microwave heating assembly 100 in some embodiments.

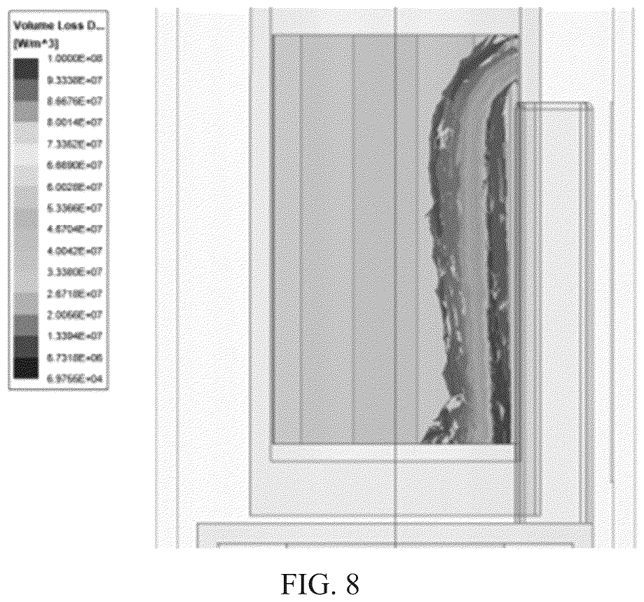

With reference to FIG. 8, energy distribution of the microwave heating assembly 100 loading the aerosol-generating article in an operation process is shown. It can be seen that under the cooperation between the first radiation structure 115 and the second radiation structure 124, the effective region in an energy field is biased towards the side at which the first radiation structure 115 and the second radiation structure 124 are located. The energy field is longitudinally and concentratively distributed. Thus, the corresponding region of the aerosol-generating article can be concentratively heated, the time required for heating part of the structure of the aerosol-generating article can be shortened, and the good instant effect can be achieved.

Understandably, in some embodiments, only a single first radiation structure 115 is arranged to cooperate with the second radiation structure 124. In some other embodiments, two or more first radiation structures 115 and two or more second radiation structures 124 may be correspondingly arranged. The single first radiation structure 115 and the second radiation structure 124 corresponding to each other belong to a same group of radiation units. Two or more groups of radiation units are arranged on the circumference Y around the central axis of the outer conductor unit 11 at intervals. The distance between the groups is properly adjusted according to required form distribution of the microwave field.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A microwave heating assembly for an aerosol generating device, comprising:
an outer conductor unit, comprising:
an outer conductor cylinder in a cylindrical shape and comprising an opened end and a closed end opposite the opened end, and
at least one first radiation structure arranged on an inner peripheral wall surface of the outer conductor cylinder; and
an inner conductor unit arranged in the outer conductor cylinder, one end of the inner conductor unit being connected to an end wall of the closed end, and an other end of the inner conductor unit extending towards the opened end, and the inner conductor unit comprising:
at least one second radiation structure corresponding to the at least one first radiation structure.

2. The microwave heating assembly of claim 1, wherein the at least one second radiation structure and the at least one first radiation structure are adjacent to each other and are arranged on a circumference of a central axis of the outer conductor cylinder separately.

3. The microwave heating assembly of claim 1, wherein the at least one first radiation structure is in an elongated shape, and
wherein a length direction of the at least one first radiation structure is arranged in a length direction of the outer conductor cylinder.

4. The microwave heating assembly of claim 3, wherein the length direction of the at least one first radiation structure is parallel to a central axis of the outer conductor cylinder.

5. The microwave heating assembly of claim 3, wherein the at least one second radiation structure is in an elongated shape and is parallel to the at least one first radiation structure.

6. The microwave heating assembly of claim 1, wherein the at least one first radiation structure comprises a first end and a second end opposite the first end, and the first end is relatively farther away from the opened end,
wherein the at least one second radiation structure comprises a first fixed end and a first free end opposite the first fixed end, and the first fixed end is relatively farther away from the opened end, and
wherein the first end is relatively closer to the first fixed end and the second end is relatively farther away from the first free end, or the first end is relatively farther away from the first fixed end and the second end is relatively closer to the first free end.

7. The microwave heating assembly of claim 1, wherein the inner conductor unit comprises:
a conductor disk comprising a first surface towards the closed end and a second surface opposite the first surface, the first surface being connected to an end wall of the closed end,
wherein the at least one second radiation structure comprises a first fixed end and a first free end opposite the first fixed end, the first fixed end being fixed to the portion, closest to an edge of the second surface, the first free end extending towards the opened end.

8. The microwave heating assembly of claim 7, wherein the conductor disk is in a disk shape, the outer conductor cylinder is in a cylindrical shape, and a diameter of the conductor disk is smaller than an inner diameter of the outer conductor cylinder.

9. The microwave heating assembly of claim 7, wherein the inner conductor unit comprises a conductor post, and the conductor disk is connected to an end wall of the closed end through the conductor post, and
wherein the conductor post comprises a second fixed end and a second free end opposite the second fixed end, the second fixed end is fixed to the end wall of the closed end, and the second free end extends in a direction of the conductor disk and is connected to the first surface.

10. The microwave heating assembly of claim 9, wherein a recess dented a the direction of the opened end is formed in the first surface, and
wherein the second free end extends into the recess and is connected to a bottom of the recess.

11. The microwave heating assembly of claim 10, wherein the recess, the conductor post, the conductor disk, and the outer conductor cylinder are coaxial.

12. The microwave heating assembly of claim 7, wherein the wall surface of the at least one second radiation structure farthest away from a central axis of the outer conductor cylinder is flush with an outer peripheral side surface of the conductor disk.

13. The microwave heating assembly of claim 1, wherein the outer conductor cylinder is partitioned off to form one accommodation cavity, and
wherein the at least one first radiation structure and the at least one second radiation structure are arranged at a periphery of the accommodation cavity separately.

14. The microwave heating assembly of claim 13, further comprising:
an accommodation base mounted at the opened end, the accommodation base comprising an accommodation portion in a cylindrical shape and configured to define the accommodation cavity.

15. The microwave heating assembly of claim 14, wherein wall surfaces of the at least one first radiation structure and the at least one second radiation structure adjacent to a central axis of the outer conductor cylinder are located at a periphery of the accommodation portion.

16. The microwave heating assembly of claim 14, wherein the at least one first radiation structure and the at least one second radiation structure are partially embedded in an outer peripheral side wall of the accommodation portion.

17. The microwave heating assembly of claim 16, wherein the wall surfaces of the at least one first radiation structure and the at least one second radiation structure adjacent to a central axis of the outer conductor cylinder are flush with an inner peripheral wall surface of the accommodation portion.

18. The microwave heating assembly of claim 16, wherein the wall surfaces of the at least one first radiation structure and the at least one second radiation structure adjacent to a central axis of the outer conductor cylinder are located inside the accommodation portion.

19. The microwave heating assembly of claim 14, wherein the accommodation base comprises a fixing portion connected to the accommodation portion, the fixing portion being mounted at the opened end and comprising one through hole so as to allow the accommodation cavity to be in communication with outside.

20. The microwave heating assembly of claim 19, wherein the accommodation portion comprises an accommodation bottom wall opposite the opened end and an accommodation side wall arranged around a periphery of the accommodation bottom wall,
wherein the accommodation base comprises a first vent recess and a second vent recess,
wherein the first vent recess is formed in an end surface of the accommodation bottom wall towards the opened end, and the second vent recess is formed in an inner peripheral wall surface of the accommodation side wall an the inner peripheral wall surface of the through hole, and
wherein the first vent recess is in communication with the outside through the second vent recess.

21. The microwave heating assembly of claim 20, wherein the first vent recess is in a sector shape, and
wherein a side of the first vent recess having a greater arc length is adjacent to the at least one first radiation structure or the at least one second radiation structure, and
wherein a side of the first vent recess having a smaller arc length is adjacent to the second vent recess.

22. The microwave heating assembly of claim 20, wherein an extension direction of the second vent recess is parallel to a central axis of the outer conductor cylinder.

23. The microwave heating assembly of claim 14, wherein the outer conductor unit comprises a first cylinder body and a second cylinder body configured to be axially combined and connected,
wherein the opened end is formed at an end of the first cylinder body farthest away from the second cylinder body, and the accommodation portion and the at least one first radiation structure are arranged in the first cylinder body, and
wherein the closed end is formed at the end of the second cylinder body farthest away from the first cylinder body, and the inner conductor unit is arranged in the second cylinder body.

24. The microwave heating assembly of claim 23, wherein the end surface of the end of the at least one first radiation structure farthest away from the opened end is flush with an end surface of the first cylinder body adjacent to the second cylinder body.

25. The microwave heating assembly of claim 23, further comprising:
a microwave feed-in unit comprising:
an outer conductor mounted on the second cylinder body and in ohmic contact with the outer conductor unit,
an inner conductor arranged in the outer conductor and in ohmic contact with an inner side of the second cylinder body or the inner conductor unit, and
a substrate layer located between the outer conductor and the inner conductor.

26. The microwave heating assembly of claim 25, wherein the second cylinder body is provided with a feeding hole so as to allow an inside of the second cylinder body to be in communication with outside,
wherein the outer conductor is embedded in the feeding hole and is in ohmic contact with an inner wall surface of the feeding hole, and
wherein the inner conductor passes through the feeding hole so as to extend into the second cylinder body.

27. An aerosol generating device, comprising:
a microwave generating assembly; and
the microwave heating assembly of claim 1,
wherein the microwave heating assembly is connected to the microwave generating assembly.
